(19) United States
(12) Patent Application Publication
(10) Pub. No.: US 2017/0042003 A1
(43) Pub. Date: Feb. 9, 2017

(54) INTELLIGENT LIGHTING AND SENSOR SYSTEM AND METHOD OF IMPLEMENTATION

(71) Applicant: STMicroelectronics, Inc., Coppell, TX (US)

(72) Inventor: Oleg Logvinov, Jersey City, NJ (US)

(21) Appl. No.: 15/230,102

(22) Filed: Aug. 5, 2016

Related U.S. Application Data
(60) Provisional application No. 62/202,067, filed on Aug. 6, 2015.

(51) Int. Cl. H05B 37/02; G05B 19/042

(52) U.S. Cl. CPC H05B 37/0272; G05B 19/0428; G05B 2219/2642; G05B 2219/45103

(57) ABSTRACT

An intelligent lighting and sensor system is disclosed that includes a processor, a memory arranged to store program logic software, the program logic software executable by the processor, a light control module in communication with at least one light source in which the operation of the light control module is directed according to the program logic software that is executed by the processor, and a sensor interface in communication with a plurality of sensor devices in which the operation of the sensor interface is directed according to the program logic software that is executed by the processor.

### TECHNICAL FIELD

The present disclosure generally relates to an intelligent lighting and sensor system and methods of implementation. More particularly, but not exclusively, the present disclosure relates to an electronic control system that may be installed in conjunction with area lighting, the electronic control system having control logic and a plurality of interfaces to permit sophisticated computing and communication operations.

### DESCRIPTION OF THE RELATED ART

Lighting modules are generally installed in a position that is elevated above an area that is intended to be lit. For example, lighting modules may be placed on poles and streetlights, on the ceilings of factory work areas, in stadiums, signage, and a wide variety of other locations.

In some situations (e.g., street lighting), individual light structures are provided with ambient light sensors for energy savings. As nighttime falls, the light sensor permits the light element to illuminate. Conversely, as daytime arises, the light sensor decreases the power supply to the light element, thereby extinguishing it.

Continuing, in other situations (e.g., street lighting), individual light structures are provided with a rudimentary controller. The rudimentary controller may be coupled to a clock, a motion detector, or some other sensor. Based on the purpose and state of the particular sensor, the rudimentary controller may determine whether or not the light element is permitted to illuminate.

In still other situations (e.g., traffic lighting), individual light structures are provided with some rudimentary network connection. This type of coordinated traffic lighting assists in the free flow of traffic by coordinating the timed (or otherwise synchronized) red-light and green-light patterns. Alternatively, or additionally, such light structures may also receive input or otherwise detect an emergency vehicle, and coordinate a traffic path so that the emergency vehicle may move unimpeded through city streets.

Notably, all of the subject matter discussed in the Background section is not necessarily prior art and should not be assumed to be prior art merely as a result of its discussion in the Background section. Accordingly, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which in and of itself may also be inventive.

### BRIEF SUMMARY

An intelligent lighting and sensor system may be summarized as including: a processor; a memory, the memory arranged to store program logic software, the program logic software executable by the processor; a light controller coupleable to at least one light source wherein the light controller is operated according to the program logic software that is executed by the processor; a sensor interface coupleable to a plurality of sensor devices wherein the sensor interface is operated according to the program logic software that is executed by the processor, the sensor devices including one or more ambient light sensors, infrared proximity sensors, image capture devices, or combinations thereof, wherein a higher light output is produced when people are detected and a lower light output is produced when people are not detected; and a spectral analysis sensor, the spectral analysis sensor receiving spectral data and distinguishing natural light from artificial light produced by other sources, wherein light output from the intelligent lighting and sensor system is dynamically adjusted in response to the received spectral data.

The processor and sensor interface may detect a fall of an individual using sensor data. The intelligent lighting and sensor system may further include a network interface that communicates with other intelligent lighting and sensor systems in a network, wherein data received from multiple intelligent lighting and sensor systems in a network enables shadows, reflections, and artificial light produced by other sources to be identified, which assists in determining proper light output from each individual intelligent lighting and sensor system. The spectral analysis sensor may determine when an object has entered a proximate area of the intelligent lighting and sensor system and may determine a size of the object based at least in part on a degree of change detected by the spectral analysis sensor. The detection of a large degree of change by the spectral analysis sensor may result in a security alert, and the detection of a small degree of change by the spectral analysis sensor may not result in a security alert. Spectral analysis by the spectral analysis sensor may be used to modify a light output by the intelligent lighting and sensor system by adjusting tones, saturation levels, hues, glare, other light parameters, or combinations thereof. The intelligent lighting and sensor system may further include a wireless controller that communicates information to and from the intelligent lighting and sensor system. The intelligent lighting and sensor system may communicate with other intelligent lighting and sensor systems and operate as network repeaters to send voice data from one system to another in a peer-to-peer configuration. The wireless controller may communicate with mobile devices worn by individuals that are proximate to the intelligent lighting and sensor system. The mobile devices may include smart phones, smart watches, tablet computers, laptop computers, automobile-based computers, or combinations thereof. The intelligent lighting and sensor system may receive information from one or more mobile devices that affects the light output of the intelligent lighting and sensor system. The intelligent lighting and sensor system may receive information from one or more mobile devices notifying the intelligent lighting and sensor system of mobile device wearers being present in a vicinity of the intelligent lighting and sensor system. The intelligent lighting and sensor system may receive information from one or more mobile devices notifying the intelligent lighting and sensor system of special needs of a mobile device wearer that is in a vicinity of the intelligent lighting and sensor system. The intelligent lighting and sensor system may send information to one or more mobile devices in response to detecting one or more mobile device wearers in a vicinity of the intelligent lighting and sensor system. The information sent from the intelligent lighting and sensor system to the one or more mobile devices may alert wearers of the mobile devices of local weather conditions. The information sent from the intelligent lighting and sensor system to the one or more mobile devices may alert wearers of the mobile devices of local traffic conditions. The information sent from the intelligent lighting and sensor system to the one or more mobile devices may include video information, audio information, textual information, tactile information, or combinations thereof. The intelligent lighting and sensor system may further include recognition systems including facial recognition, biometric recognition, or combinations thereof. The intelligent lighting and sensor system may be incorporated into a traffic control signal and may be used in automobile traffic control. The intelligent lighting and sensor system may be incorporated into a crosswalk signal and may be used in pedestrian traffic control. The intelligent lighting and sensor system may further include a security logic system coupleable to at least one security device. The security logic system may include a short range secure controller that includes a near field communication (NFC) controller, a radiofrequency identifier (RFID) controller, or combinations thereof. The intelligent lighting and sensor system may notify remote safety personnel of a security event or an emergency event. The intelligent lighting and sensor system may provide emergency lighting in response to a security event or an emergency event, wherein emergency lighting includes flashing lights, strobe lighting, sequential lighting, colored lighting, or combinations thereof. The intelligent lighting and sensor system may further include an audio controller coupleable to at least one audio device wherein the operation of the audio controller is directed according to the program logic software executed by the processor, wherein the audio controller sounds an alarm in response to a security event or an emergency event. The audio controller may enable remote safety personnel to speak to local individuals in response to a security event or an emergency event. An emergency event may include a fall of an individual, a traffic accident between vehicles, a traffic accident involving a vehicle and a pedestrian, a traffic accident involving vehicle and a stationary object, or combinations thereof. The security event may include an attack on an individual, a robbery of an individual, burglary, trespassing, malicious mischief, or other act of violence. The power entry device may conform to a HomePlug protocol. The wireless controller may conform to at least one of a cellular protocol and a WiFi protocol.

A method of providing intelligent lighting in response to sensed information may be summarized as including: providing a processor and a memory, the memory arranged to store program logic software that is executable by the processor; receiving light and image information via a sensor interface and a plurality of sensor devices, the sensor devices including one or more ambient light sensors, infrared proximity sensors, image capture devices, or combinations thereof; producing, a light controller coupleable to at least one light source, a higher light output is produced when people are detected and a lower light output is produced when people are not detected; and receiving spectral data, via a spectral analysis sensor, and distinguishing natural light from artificial light produced by other sources, wherein light output from the intelligent lighting and sensor system is dynamically adjusted in response to the received spectral data.

An intelligent lighting and sensor system may be summarized as including: a plurality of intelligent lighting and sensor systems connected via a network, each intelligent lighting and sensor system comprising: a processor; a memory, the memory arranged to store program logic software, the program logic software executable by the processor; a light controller coupleable to at least one light source wherein the light controller is operated according to the program logic software that is executed by the processor; a sensor interface coupleable to a plurality of sensor devices wherein the sensor interface is operated according to the program logic software that is executed by the processor, wherein the sensor devices includes one or more ambient light sensors, infrared proximity sensors, image capture devices, or combinations thereof; and a spectral analysis sensor, the spectral analysis sensor receiving spectral data and distinguishing natural light from artificial light produced by other sources, wherein light output from the intelligent lighting and sensor system is dynamically adjusted in response to the received spectral data.

Within the intelligent lighting and sensor system and methods discussed in the present disclosure, highly functional Internet-accessible devices are described. The innovation described in the present disclosure is new and useful, and the innovation is not well-known, routine, or conventional in the lighting industry.

The innovation described herein combines building blocks in new and useful ways along with other structures and limitations to create something more than has heretofore been conventionally known. The embodiments improve on lighting module computing systems which, when un-programmed or differently programmed, cannot perform or provide the specific intelligent lighting system features claimed herein.

The embodiments described in the present disclosure improve upon known lighting processes and techniques. Additionally, the computerized acts described in the embodiments herein are not purely conventional and are not well understood. Instead, the acts are new to the industry. Furthermore, the combination of acts as described in conjunction with the present embodiments provides new information, motivation, and technological results that are not already present when the acts are considered separately.

These features with other technological improvements, which will become subsequently apparent, reside in the details of construction and operation as more fully described hereafter and claimed, reference being had to the accompanying drawings forming a part hereof.

### BRIEF DESCRIPTION OF THE SEVERAL VIEWS OF THE DRAWINGS

The present application will be more fully understood by reference to the following figures, which are for illustrative purposes only. These non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. The figures do not describe every aspect of the teachings disclosed herein and do not limit the scope of the claims.

FIG. 1A illustrates the use of intelligent lighting and sensor systems in an urban environment.

FIG. 1B illustrates the use of intelligent lighting and sensor systems in a suburban environment.

FIG. 1C illustrates the use of intelligent lighting and sensor systems in a rural environment.

FIG. 2 illustrates the circuit board of one embodiment of an intelligent lighting and sensor system.

### DETAILED DESCRIPTION

Persons of ordinary skill in the art will understand that the present disclosure is illustrative only and not in any way limiting. Other embodiments of the presently disclosed system and method readily suggest themselves to such skilled persons having the assistance of this disclosure.

Each of the features and teachings disclosed herein can be utilized separately or in conjunction with other features and teachings to provide an intelligent lighting and sensor system and method of implementation. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” “configuring,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present application also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

As used in the present disclosure, the term “module” refers to an application specific integrated circuit (ASIC), an electronic circuit, a processor and a memory operative to execute one or more software or firmware programs, combinational logic circuitry, or other suitable components (hardware, software, or hardware and software) that provide the functionality described with respect to the module.

Additionally, a lighting structure as herein defined is any structure on which a light source may be affixed. A lighting structure may be a pole, the side of a building, a tower, a ceiling, a roof, a motor vehicle, the bottom of a boat, a cable, or any other like or suitable structure to which a light source may be coupled. Notably, the intelligent lighting and sensor system 100 leverages the value of the locations of particular lighting structures for a wide variety of useful benefits ranging from safety to energy efficiency.

Lighting structures are a useful and desirable technological asset. To provide useful lighting, light sources are affixed to lighting structures in areas where people like or need to frequently travel. Additionally, lighting structures typically are located in areas having direct line of sight to large volumes of space. For example, streetlights are elevated above and alongside roadways, factory lighting and other indoor lighting is placed on the ceiling, and illuminated signage is placed where a high number of people will see the sign. Notably, technological benefits may be achieved if lighting structures were used for more than simply a mounting point for a light source. Conversely, the available area where light sources are mounted is not unlimited. In this manner, often size, weight, power, and other factors limit the available use that can be made of the area.

Accordingly, the intelligent lighting and sensor system provides a technological improvement over conventional light source controllers. The intelligent lighting and sensor system discussed in the present disclosure is configured to control one or more light sources in proximity to the system. Additionally, the intelligent lighting and sensor system includes control logic and a plurality of interfaces to permit sophisticated computing and communication operations.

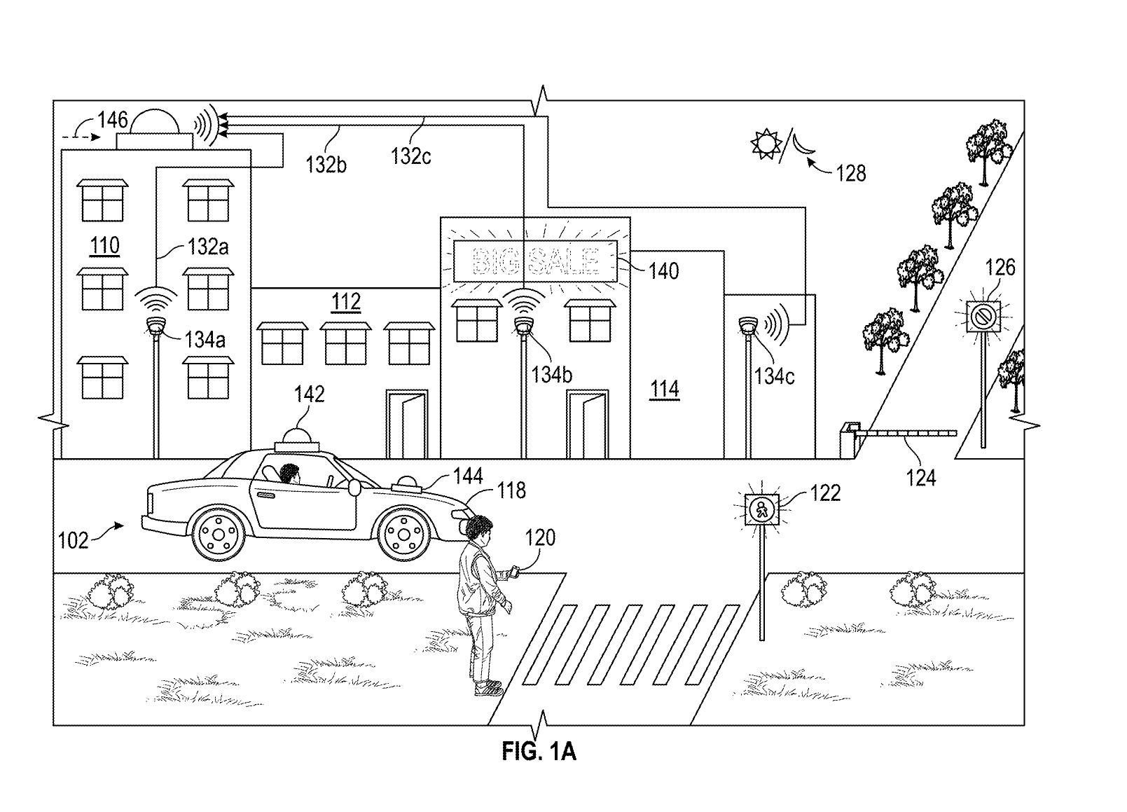

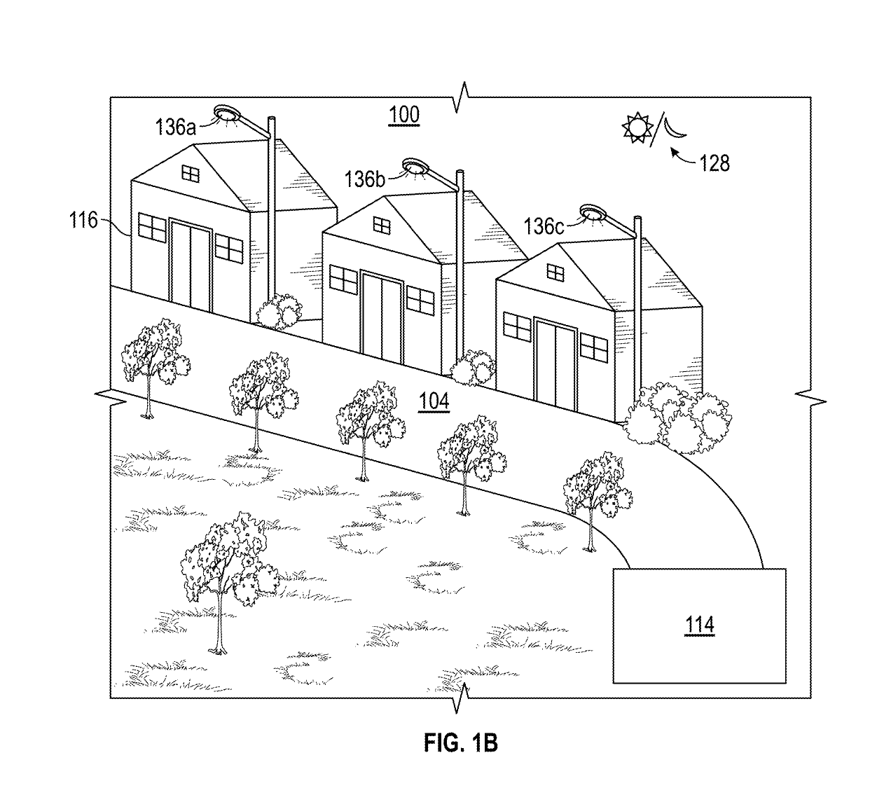

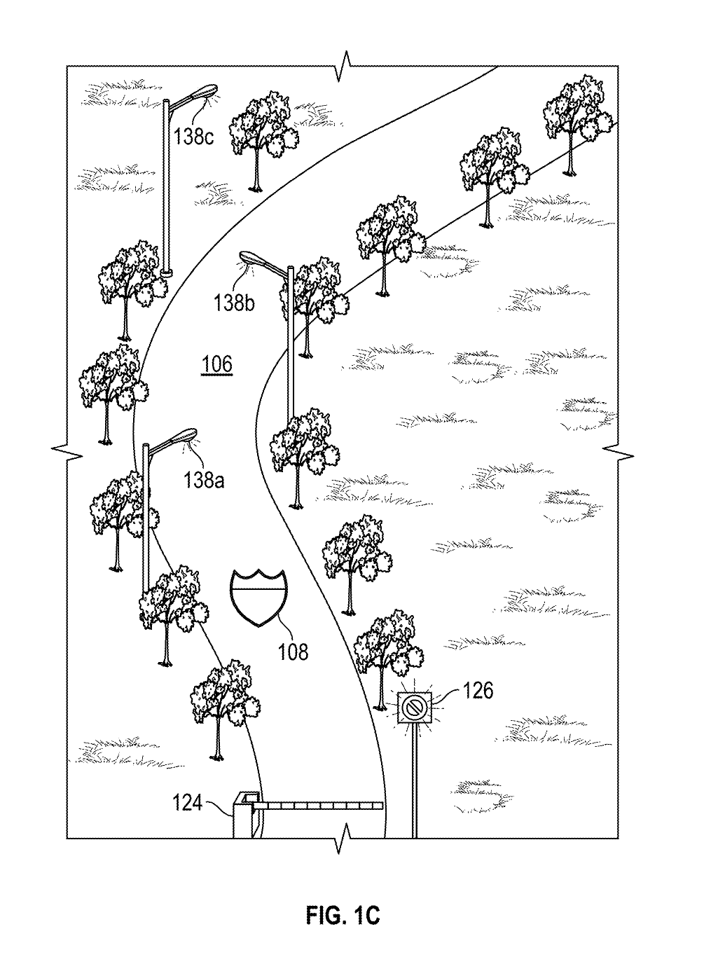

FIGS. 1A, 1B, and 1C illustrate a plurality of embodiments of an intelligent lighting and sensor system 100. In FIG. 1A, an urban environment 102 is shown with dense building placement, city streets and sidewalks adjacent to buildings, areas were many cars and pedestrians are present, and the like. In FIG. 1B, a suburban environment 104 is shown of an area with less dense building structures and more open space. Referring now to FIG. 1C, a rural area 106 is shown of an area that is even less densely populated than the suburban environment 104, having few if any structures. Nevertheless, as indicated by interstate highway 108, rural areas serve people (and in many cases, a great number of people) who are moving in and through the rural area.

Referring again to FIG. 1A, in one embodiment the urban environment 102 includes large office/residential buildings 110 which may be high rise or medium rise buildings, municipal buildings 112, commercial buildings 114, and many other types of open and closed structures. The urban environment 102 may also include bridges, archways, crosswalks, tunnels, catwalks, and any other types of structures. In contrast, the suburban environment 104 (FIG. 1B) may include many residential housing units such as single and multifamily houses, smaller apartment buildings, garages, sheds, barns, and many other types of natural and man-made structures. Continuing, in a rural environment 106 (FIG. 1C) there may be very few man-made structures besides a highway, signage, and lighting structures.

The intelligent lighting and sensor system 100 of the present disclosure may be implemented in many different environments. Notably, the urban environment 102, the suburban environment 104, and the rural environment 106 all contain streets. Typically, these urban, suburban, and rural streets are driven upon by motor vehicles 118. Accordingly, a plurality of intelligent lighting and sensor systems may be deployed in urban environments 102, suburban environments 104, and rural environments 106 to assist with a wide variety of situations including: (1) providing intelligent lighting to these driving environments in response to sensor input; (2) producing an alarm if an accident is detected; (3) contacting emergency services in response to an accident that is detected; and (4) providing emergency lighting (flash, strobe, colored, or the like) to alert local individuals of an emergency situation. In this regard, some embodiments of the intelligent lighting and sensor system 100 may include one or more image capture devices, such as video cameras.

In other embodiments of the intelligent lighting and sensor systems 100, the intelligent lighting and sensor systems facilitate communication with people in the surrounding area via any number of mobile devices 120 (e.g., smart phones, tablets, smart watches, other wearable computing devices, and the like) which are commonly worn by individuals today. In one aspect, the intelligent lighting and sensor systems 100 may receive information from the mobile devices 120 that affects the output of the intelligent lighting and sensor systems. In some embodiments, the input from the mobile devices 120 is more basic and simply alerts the intelligent lighting and sensor systems to the presence of the mobile device wearer. In other embodiments, the input from the mobile devices 120 is more complex and alerts the intelligent lighting and sensor systems to specific needs of the mobile device wearer (e.g., maximum lighting due to special needs of the mobile device wearer, an audible sound due to special needs of the mobile device wearer, and the like).

In another aspect, the intelligent lighting and sensor systems 100 may send information to the mobile devices 120 when the intelligent lighting and sensor systems have sensed the presence of the mobile device (and its wearer). In some embodiments, the output from the intelligent lighting and sensor systems to the mobile devices 120 alerts the mobile device wearer of freezing conditions (e.g., in an intelligent lighting and sensor system that includes a temperature sensor or an interface for receiving communicated temperature information). In other embodiments, the output from the intelligent lighting and sensor systems to the mobile devices 120 alerts the mobile device wearer of traffic conditions (e.g., in an intelligent lighting and sensor system that includes video sensors, motion sensors, or an interface for receiving communicated traffic information).

In still other embodiments, the intelligent lighting and sensor systems 100 may be incorporated into safety devices. For example, in locations where people are typically present, safety devices 122 such as crosswalk signs are often present, which may incorporate the intelligent lighting and sensor systems 100. Many other types of safety devices are also contemplated, including a traffic control device 124 and a traffic signal 126. All of these safety devices incorporate the intelligent lighting and sensor systems 100.

The urban, suburban, and rural areas are located under the sun and moon 128, which are associated with natural light, such as ambient light 146, dusk (e.g., rapidly diminishing light), and darkness (e.g., little to no light). The intelligent lighting and sensor systems 100 may sense the natural light and adjust accordingly the amount of the light that the intelligent lighting and sensor systems should provide. By using a plurality (or network) of interconnected intelligent lighting and sensor systems, the interconnected intelligent lighting and sensor systems may produce a more accurate determination of the natural light or ambient light by eliminating or diminishing the reliance on lighting information from a single intelligent lighting and sensor system that may provide outlier data due to shadows, headlights, or other transient light-adjusting cause. The plurality of interconnected intelligent lighting and sensor systems may also include a network connection that enables the intelligent lighting and sensor systems to receive weather information, dawn/dusk information, or other related information that may affect the amount of natural/ambient light sensed. The plurality of interconnected intelligent lighting and sensor systems may use this information to identify outlier data that is sensed and produce a more accurate determination of the natural light or ambient light.

Several intelligent lighting systems are illustrated in FIGS. 1A, 1B, and 1C. For example, in FIG. 1A a “building-mounted” intelligent lighting system 130 is affixed to a large office/residential building 110. As described herein, exemplary communications may be received via wired paths 132a, wireless paths from a short distance 132b, and wired and wireless paths 132c, which may cover long or short distances. In this manner, embodiments of intelligent lighting and sensor systems are shown in an urban environment 134a, 134b, 134c in FIG. 1A, embodiments of intelligent lighting and sensor systems are shown in a suburban environment 136a, 136b, 136c in FIG. 1B, and embodiments of intelligent lighting and sensor systems are shown in a rural environment 138a, 138b, 138c in FIG. 1C.

In yet another embodiment shown to FIG. 1A, the intelligent lighting and sensor system is mounted on, or otherwise integrated with, a commercial lighted sign 140 of a commercial building 114. In one aspect, the intelligent lighting and sensor systems 100 in the commercial lighted sign 140 may receive information (input) from the mobile devices 120 that affects the output of the intelligent lighting and sensor systems. In another aspect, the intelligent lighting and sensor systems 100 in the commercial lighted sign 140 may send information (output) to the mobile devices 120 when the intelligent lighting and sensor systems have sensed the presence of the mobile device (and its wearer).

Referring again to FIG. 1A, another embodiment of the intelligent lighting and sensor system 100 is also shown that is mounted to the roof of a motor vehicle 142. The motor vehicle 142 may be a municipal vehicle such as a police car, a public service vehicle (e.g., a taxi, a trolley, a shuttle bus, and the like), a commercial vehicle such as a truck or limousine, or any other type of motor vehicle. In one aspect, the intelligent lighting and sensor systems 100 of motor vehicle 142 may receive information (input) from the mobile devices 120 that affects the output of the intelligent lighting and sensor systems. In another aspect, the intelligent lighting and sensor systems 100 of the motor vehicle 142 may send information (output) to the mobile devices 120 when the intelligent lighting and sensor systems have sensed the presence of the mobile device (and its wearer). In some cases, portable intelligent lighting systems 144 are also contemplated.

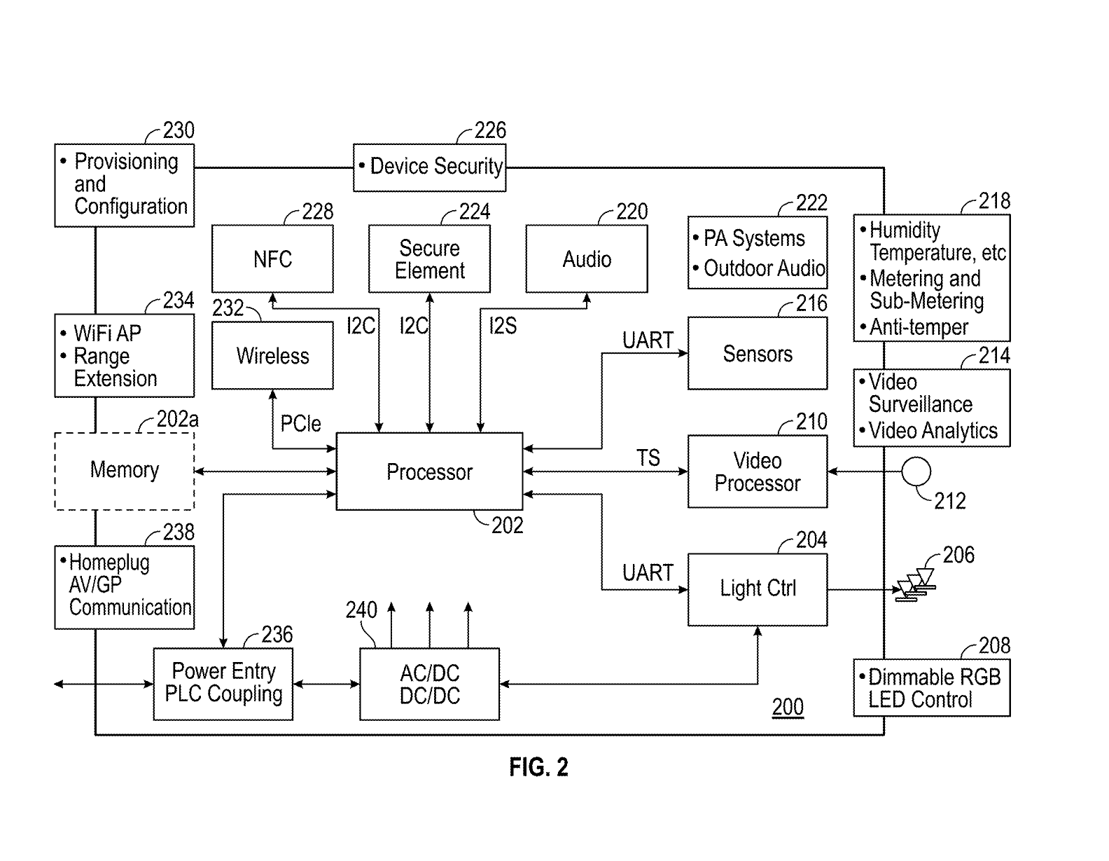

FIG. 2 illustrates one embodiment of an intelligent lighting module control unit 200. The intelligent lighting module control unit 200 includes a processor 202 coupled to a memory 202a. In this embodiment, the processor 202 is also coupled to a lighting control 204, a video processor 210, a sensor interface 216, an audio controller 220, a security controller 224, a short range secure controller 228, and a wireless controller 232. Additionally, in this embodiment a power entry device 236 is coupled to a device power supply 236 that receives, controls, and distributes power to the intelligent lighting module control unit 200 and its associated devices.

In one embodiment, the processor 200 is a STREAMPLUG ST2100 type device from STMICROELECTRON ICS. In some embodiments, the processor is a broad band powerline communication device having an ARM926 core based on a design from ADVANCED RISC MACHINES (ARM). The processor 202 may be formed as an integrated circuit (IC). In some cases, the processor is a standalone integrated circuit. In other cases, some or all of the modules represented in the intelligent control module control unit 200 of FIG. 2 are formed in the same integrated circuit as the processor 202.

FIG. 2 illustrates the processor 202 as having a plurality of data transport paths that conform to a variety of proprietary and standardized protocols. In one embodiment, the processor 202 is illustrated as having a universal asynchronous receiver/transmitter (UART) serial bus, a transport stream (TS) bus, an Inter-IC Sound (i.e., I2S, IIS, or I²S) bus, an Inter-Integrated Circuit (i.e., I2C, IIC, or I²C) bus, or a Peripheral Component Interconnect Express (PCIe) bus. A plurality of other buses may also be used without departing from the scope of the present disclosure.

The memory 202a in the intelligent control module control unit 200 is illustrated in dashed lines in FIG. 2. In this embodiment, the dashed lines represent that memory 202a may be a local memory, a remote memory, or some combination of local and remote memory. Additionally, the memory 202a may be internal to the intelligent control module control unit 200, external to the intelligent control module control unit 200, or have some portions internal and other portions external to the intelligent control module control unit 200.

In one embodiment, the lighting control 204 is an STLUX385 digital controller for lighting and power from STMICROELECTRONICS. Other lighting controllers are also contemplated. In some cases, the lighting control 204 includes a programmable processor and memory. The lighting control may include one or more pulse width modulation (PWM) generators to provide control signals that direct light sources coupled to the lighting control 204. The lighting control 204 may include one or more digital addressable lighting interfaces (DALI), comparators, analog to digital controllers (ADC), one or more clocks, and other peripheral devices such as timers, generally programmable input/output (GPIO) ports, communication interfaces, and electronic structures to provide additional features.

In FIG. 2, the lighting control 204 is illustrated as being in communication with a plurality of light sources 206. The light sources 206 may be any type of light source including light emitting diode (LED)—based light sources. The light sources may be used as street lighting, general area lighting, interior or exterior lighting, signage lighting, video display lighting, safety device lighting, and any other type of light source. Also in FIG. 2, the lighting control 204 is coupled to a dimmable red-green-blue (RGB) LED control module 208. The dimmable RGB LED control module 208 may be used to control the light sources 206.

Additionally, in some embodiments the processor 202 is coupled to a video processor 210. In turn, the video processor 210 is in communication with a video I/O device 212. The video processor 210 is also in communication with other video logic modules and devices 214, including a video surveillance module and a video analytics module. In some embodiments, the video I/O device 212 may be a video input device, a video output device, or a video device capable of transmitting video and receiving video. Furthermore, the video I/O device 212 generally employs signal processing logic to convert video data of one format into video data of another format. A wide variety of processing, scaling, interlacing, de-interlacing, buffering, and streaming features may be employed. The video processor 210 may also include advanced video processing features such as infrared or other night-vision technology, facial recognition technology, proximity and target tracking technology, and the like.

Continuing, in some embodiments the processor 202 is coupled to a sensor interface 216. The sensor interface 216 may be in communication with any number and type of sensors. A variety of sensory logic modules and devices 218 are illustrated in FIG. 2 including humidity sensors, temperature sensors, metering and sub-metering sensors, and anti-tampering sensors. Ambient light sensors, active light sensors, infrared sensors or other sensors associated with light that is not visible to the human eye are also contemplated.

In an aspect of some embodiments, the processor 202 is coupled to an audio controller 220. The audio controller 220 may be in communication with one or more audio logic modules and devices 222. A public address (PA) system and outdoor audio modules are illustrated in FIG. 2. Other audio features may also be employed in some embodiments, such as streaming audio, horns, or other sound producing devices (e.g., sirens, buzzers, and the like) for safety and other purposes.

In one embodiment, the intelligent light control module control unit 200 includes secure controller 224 that is also coupled to the processor 202. In FIG. 2, the secure controller 224 is in communication with one or more security logic modules and devices 226. In some embodiments, the secure controller 224 is a short range secure controller. In this regard, the short range secure controller may be a near field communication (NFC) controller, a radiofrequency identifier (RFID) controller, or some other controller that is in communication with the one or more security logic modules and devices 226. Additionally, or alternatively, the short range secure controller (which may be wired or wireless) may be employed for provisioning and configuration features 230.

In some embodiments, one or more wireless controllers 232 transmit data to or from the intelligent lighting module control unit 200. The one or more wireless controllers 232 may conform to a short range standard such as IEEE 802.11 (e.g., WiFi), a cellular standard, or some other protocol. Wireless controller logic and devices 234 such as a WiFi access point (AP), and a range extender may be in communication with the one or more wireless controllers 232.

In another aspect of some embodiments, a power logic and control device module 238 conforms to a standardized protocol such as the HOMEPLUG POWERLINE ALLIANCE, which permits devices to communicate with each other and with the Internet over existing electrical wiring.

Using the one or more wireless controllers 232, the power logic and control devices module 238, or some other communication interface, the intelligent lighting module control unit 200 may communicate over the Internet. Each intelligent lighting module control unit 200 may be individually addressable on the Internet or individually addressable within some other network such that the particular intelligent lighting module control unit 200 may send or receive information.

In another aspect of some embodiments, the power entry, PLC coupling device 236 includes one or more high-voltage-coupling transformers to protect equipment and people from electric shock while reproducing PLC data signals across an isolation barrier. Accordingly, via the power entry, PLC coupling device 236, the intelligent lighting module control unit 200 may further send or receive information across the Internet or across some other wide area network (WAN) or local area network (LAN).

Continuing, in some embodiments, a power supply 240 of the intelligent lighting module control unit 200 may include a device that converts alternating current (AC) to direct current (DC) to power internal or external devices of the intelligent lighting module control unit 200. The power supply 240 may also include a DC/DC power supply or some other switched mode power supply to provide useful power to internal and external devices of the intelligent lighting module control unit 200.

Exemplary embodiments of the intelligent lighting module control unit 200 in FIG. 2 are now described as employed in FIGS. 1A-1C. In one implementation, a plurality of intelligent module control units 200 are deployed on a college campus. The individual intelligent lighting control modules may include ambient light sensors and infrared proximity sensors. The sensors work cooperatively for safety and energy conservation. For example, when one of the intelligent lighting module control units 200 detects that people are present, the detection may be used to raise light output. Conversely, when no people are detected, output from the light source may be lowered. As an alternative to infrared proximity sensors, other types of sensors such as motion detection sensors through a video camera may also be used.

In an environment where an intelligent lighting module control unit 200 includes one or more image capture devices such as video cameras, other safety features may also be provided. The video camera may detect motion of a person, and the processing of video data may include fall detection. That is when a person on a college campus or in some other environment is detected as having fallen, and if the person does not get up, then an alarm may be enabled. The alarm may include on alert to security personnel, and an audio device may be enabled to allow safety personnel to speak out loud to the person who might have fallen to determine if additional help is needed. Similar video and video processing features may be used to detect an attack on a person or some other violence. When video processing features include motion recognition, facial recognition, or other types of recognition, the intelligent lighting module control unit 200 may be used to facilitate a wide range of responses.

The intelligent lighting module control unit 200 may include spectral analysis sensors and processing. The intelligent lighting module control unit 200 may be able to determine and distinguish natural light from artificial light produced by other sources. In this way the amount of light output may be adjusted dynamically for energy conservation. For example, when sufficient natural light is available, the individual light output from the light sources may be reduced. A mere reduction, however, may not save all of the power that is available to be saved. For example, as the sun passes over a particular area, shadowing will provide moment-by-moment changes to the volume and direction of useful light that is perceived as necessary from any particular light source.

Reflections of light from one source may reduce the amount of light necessary from another source. The shadowing and reflection may be created by permanent sources such as buildings or trees. The shadowing and reflection may be created by temporary sources such as moving vehicles. As another example, when foliage grows over the course of a season to prevent light from reaching one area that previously was reached, the intelligent lighting module control unit 200 may detect the change and adjust light output accordingly. In addition, upon such a detection of change in the nearby environment, the intelligent lighting module control unit 200 may cause an automated request for service.

By using a plurality (or network) of interconnected intelligent lighting and sensor systems, the interconnected intelligent lighting and sensor systems may produce a more accurate determination of the natural light or ambient light by eliminating or diminishing any reliance on lighting information from a single intelligent lighting and sensor system that provides outlier data due to shadows, headlights, or other transient light-altering causes. The plurality of interconnected intelligent lighting and sensor systems may also include a network connection that enables the intelligent lighting and sensor systems to receive weather information, dawn/dusk information, or other related information that may affect the amount of natural/ambient light expected to be sensed. The plurality of interconnected intelligent lighting and sensor systems may use this information to identify outlier data that is sensed and produce a more accurate determination of the natural light or ambient light.

Spectral analysis can also be used for security. For example when an object enters an area, the spectrum of light within the area will change. One or more intelligent lighting and sensing system may be used to summon security when the spectrum changes or when the spectrum changes in a detectable way (e.g., summon security when an object the size of a human is detected, but not when an object the size of a cat is detected).

One more way that spectral analysis can be used is to augment natural lighting. A modification to the light produced by a light source may be made to adjust for particular tones, saturation levels, colors, hues, glares, or other parameter of the light. The modification may be automatic or manual. In one embodiment, information communicated from a mobile device 120 regarding the age or special needs of the proximate individual may be used to adjusted the light levels or other parameter of the light.

Turning back to the embodiment of FIG. 1A, intelligent lighting module control units 200 may be used in safety devices 122, traffic control devices 124, and traffic signals 126 and provide a wide variety of features. The devices may operate one way when people are in proximity and operate a different way when no people are detected. The devices may be controlled remotely to facilitate safety associated with crowd control, traffic control, or for other purposes.

In one implementation, the safety device 122 is configured to communicate with a short range wireless protocol to a mobile device 120 held by a person. The safety device 122 can push messages that provide video, audio, textual, tactile, or other indicators to a person. If the person is not otherwise paying attention to an unsafe condition, the message received through the mobile device 120 will be very valuable.

Communications 132a, 132b, 132c illustrated in FIG. 1A indicate that autonomous and automatic cooperation may be performed between a plurality of intelligent lighting module control units 200. While only three communication paths are shown, many other communication paths are understood. The autonomous and automatic communications may be used for the cooperative lighting features described herein, for many purposes. For example, the communications may be provided in an emergency, for example, when a cellular infrastructure is unavailable. In this way, intelligent lighting module control units 200 operate as network repeaters to couple voice or data from one peer to another.

In another embodiment, intelligent lighting module control units 200 may be used to improve commercial signage. The intelligent lighting module and a commercial sign 140 may include object detection so as to conserve energy when no people are present. The intelligent lighting module control unit 200 of a commercial sign may have recognition features (e.g., facial recognition, biometric recognition, and the like) such that particular advertising may be directed to the customer visually, audibly, through a mobile device, or in some other manner.

Various aspects of the systems, methods, functions, steps, features and the like corresponding thereto disclosed herein may be implemented on one or more computer systems using hardware, software, firmware, circuits, or combinations thereof. Hardware, software, firmware, and circuits respectively refer to any hardware, software, firmware, or circuit component. Computer systems referred to herein may refer to any computing device and vice versa (e.g., smart phone, mobile computing device, personal data assistant, tablet computer, laptop computer, desktop computer, other computing device, and the like). For example, each computer system or computing device in the systems described herein or any embodiment of a system disclosed herein may utilize one or more of the following components: a single-core or multi-core hardware processor (e.g., central processing unit or graphics processing unit) on which software instructions are executed (e.g., instructions corresponding to an operating system, an application program, an interpreter such as a virtual machine, or a compiler); a memory associated with and in connection with the hardware processor such as cache or other system memory that stores software instructions or other data that the hardware processor may access for processing; an input device (e.g., mouse, keyboard, touchscreen, and the like); an output device (e.g., display, touchscreen, printer, and the like); a network or communication interface that enables the computer system to communicate over a network or communication protocol; an application program having corresponding software instructions that are executable by a hardware processor. Connections between different computer systems and connections between different computer system components may be wired or wireless.

Virtualization computing techniques, cloud computing techniques, web application/website computing techniques, traditional and adaptive streaming techniques, and other computing techniques may be implemented by any embodiment of a system disclosed herein to enable and/or enhance the teachings described herein. For example, in a cloud computing embodiment, one or more servers (i.e., one or more computer systems) may store and execute software instructions corresponding to an application program based on input data received from client devices. In response to the input data received, the application program is executed accordingly, which results in graphical data being processed and output to the client devices for display on a display such as a touch screen on a smart phone or tablet computer.

As another example, in a web application or website embodiment, data representative of a user input may be transmitted to a server (i.e., a computer system) hosting the website for processing and storage in memory. In an application program embodiment, the application may be stored and executed locally on a user's computer system. In other embodiments, one or more components of the application program may be stored and executed on a server and the user's computer system. For example, a user may download the application program from an app store for an Android computing device, Blackberry computing device, Apple computing device, Windows computing device, Samsung computing device, other computing device, and the like. Execution of the application program on the user's computing device may require that the device transmit and receive data to and from one or more computing devices such as a server or other user's computing device. For example, an application may be downloaded from a server to a mobile device. Upon installation, the mobile device may communicate with a server.

One or more embodiments of the systems disclosed herein may utilize streaming technology. Streaming data enables data to be presented to the user of the client device while the client device receives data from the server. Streaming data from servers to client devices (e.g., computing devices operated by users) over a network is typically limited by the bandwidth of the network, or alternatively, the physical layer net bitrate. Traditional streaming protocols, such as RTSP (Real-Time Streaming Protocol), MS-WMSP (Windows Media HTTP Streaming Protocol), and RTMP (Real-Time Messaging Protocol) may be implemented, which essentially send data in small packets from the server to the client device in real-time at the encoded bitrate of the data. Adaptive streaming may also be implemented. Adaptive streaming almost exclusively relies on HTTP for the transport protocol. Similar to traditional streaming, data is encoded into discrete packets of a particular size; however, the source data is encoded at multiple bitrates rather than a single bitrate. The data packets corresponding to the same data encoded at different bitrates are then indexed based on the bitrate in memory. This streaming method works by measuring, in real-time, the available bandwidth and computer capacity of the client device, and adjusts which indexed data packet to transfer based on the encoded bitrate.

One or more aspects of the systems disclosed herein may be located on (i.e., processed, stored, executed, or the like; or include one or more hardware or software components) a single computer system or may be distributed among a plurality of computer systems attached by one or more communication networks (e.g., internet, intranet, a telecommunications network, and the like). One or more components of a computer system may be distributed across one or more computer systems in communication with the computer system over a communication network. For example, in some embodiments, the systems disclosed herein may utilize one or more servers (i.e., one or more computer systems dedicated for a particular purpose in the system) that may be dedicated to serve the needs of one or more other computer systems or components across a communication network and/or system bus. The one or more servers may provide a central processing location for one or more aspects of the systems disclosed herein.

Those of ordinary skill in the art will appreciate that one or more circuits and/or software may be used to implement the system and methods described herein. Circuits refer to any circuit, whether integrated or external to a processing unit such as a hardware processor. Software refers to code or instructions executable by a computing device using any hardware component such as a processor to achieve the desired result. This software may be stored locally on a processing unit or stored remotely and accessed over a communication network.

As disclosed herein, a processor may refer to any hardware processor or software processor. A software processor may include or otherwise constitute an interpreter that is executed by a corresponding hardware processor. A computer system according to any embodiment disclosed herein is configured to perform any of the described functions related to the various embodiments of the systems disclosed herein.

As disclosed herein, the phrase “executed by a computing device” includes execution by any hardware component (e.g., CPU, GPU, network interface, integrated circuits, other hardware components, and the like) of the computing device such as a hardware processor. Any module may be executed by a computing device (e.g., by a processor of the computing device). Any method, function, step, feature, result, and the like disclosed herein may be implemented by one or more software modules whether explicitly described or not. Individual components within a computing device may work together to accomplish a desired method, function, step, feature, or result. For example, a computing device may receive data and process the data. A simple example would be that a network interface receives the data and transmits the data over a bus to a processor.

Various aspects of the systems disclosed herein may be implemented as software executing in a computer system. The computer system may include a central processing unit (i.e., a hardware processor) connected to one or more memory devices, a graphical processing unit, input devices such as a mouse and keyboard, output devices such as speakers and a display, a network interface to connect to one or more other computer systems (e.g., one or more computer systems configured to provide a service such that function as a database), an operating system, a compiler, an interpreter (i.e., a virtual machine), and the like. The memory may be used to store executable programs and data during operation of the computer system. The executable programs may be written in a high-level computer programming language, such as Java or C++. Of course, other programming languages may be used since this disclosure is not limited to a specific programming language or computer system. Further, it is to be appreciated that the systems and methods disclosed herein are not limited to being executed on any particular computer system or group of computer systems.

Some methods, functions, steps, or features have been described as being executed by corresponding software by a processor. It is understood than any methods, functions, steps, features, or anything related to the systems disclosed herein may be implemented by hardware, software (e.g., firmware), or circuits despite certain methods, functions, steps, or features having been described herein with reference to software corresponding thereto that is executable by a processor to achieve the desired method, function, or step. It is understood that software instructions may reside on a non-transitory medium such as one or more memories accessible to one or more processors in the systems disclosed herein. For example, where a computing device receives data, it is understood that the computing device processes that data whether processing the data is affirmatively stated or not. Processing the data may include storing the received data, analyzing the received data, and/or processing the data to achieve the desired result, function, method, or step. It is further understood that input data from one computing device or system may be considered output data from another computing device or system, and vice versa. It is yet further understood that any methods, functions, steps, features, results, or anything related to the systems disclosed herein may be represented by data that may be stored on one or more memories, processed by one or more computing devices, received by one or more computing devices, transmitted by one or more computing devices, and the like.

Certain words and phrases used in the specification are set forth as follows. As used throughout this document, including the claims, the singular form “a”, “an”, and “the” include plural references unless indicated otherwise. For example, “a” lighting control includes one or more lighting controls. Any of the features and elements described herein may be singular, e.g., a sensor may refer to one sensor and a memory may refer to one memory. The terms “include” and “comprise,” as well as derivatives thereof, mean inclusion without limitation. The term “or,” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation, such a device may be implemented in hardware, firmware, or software, or some combination of at least two of the same. The functionality associated with any particular controller may be centralized or distributed, whether locally or remotely. Other definitions of certain words and phrases are provided throughout this patent document. Those of ordinary skill in the art will understand that in many, if not most instances, such definitions apply to prior as well as future uses of such defined words and phrases.

A processor (i.e., a processing unit), as used in the present disclosure, refers to one or more processing units individually, shared, or in a group, having one or more processing cores (e.g., execution units), including central processing units (CPUs), digital signal processors (DSPs), microprocessors, micro controllers, state machines, and the like that execute instructions. The processors interchangeably refer to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory or may be hard-coded as a state machine or set of control signals. According to methods and devices referenced herein, embodiments describe software executable by the processor and operable to execute certain ones of the method acts.

In the present disclosure, memory may be used in a variety of configurations. As known by one skilled in the art, each memory comprises any combination of volatile and non-volatile, transitory and non-transitory computer-readable media for reading and writing. Volatile computer-readable media includes, for example, random access memory (RAM). Non-volatile computer-readable media includes, for example, read only memory (ROM), magnetic media such as a hard-disk, an optical disk drive, a flash memory device, a CD-ROM, and/or the like. In some cases, a particular memory is separated virtually or physically into separate areas, such as a first memory, a second memory, a third memory, and the like. In these cases, it is understood that the different divisions of memory may be in different devices or embodied in a single memory. The memory may be configured to store data.

In the alternative or in addition, the memory may be a non-transitory computer readable medium (CRM) wherein the CRM is configured to store instructions executable by a processor. The instructions may be stored individually or as groups of instructions in files. The files may include functions, services, libraries, and the like. The files may include one or more computer programs or may be part of a larger computer program. Alternatively or in addition, each file may include data or other computational support material useful to carry out the computing functions of the systems, methods, and apparatus described in the present disclosure.

As used herein, “cellular” is intended in a broad sense to include any of the variety of known modes of wireless or mobile voice communications, data communications, or voice and data communications. Exemplary cellular systems include, but are not limited to, time division multiple access (“TDMA”) systems, code division multiple access (“CDMA”) systems, and Global System for Mobile communications (“GSM”) systems. Other exemplary cellular systems include systems known in the art as “3G” systems, “4G” systems, “5G” systems, Enhanced Data Rates for GSM Evolution (“EDGE”) systems, and other systems.

Intelligent lighting module control unit 200 may further include operative software found in a conventional embedded device such as an operating system, software drivers to direct operations through the I/O circuitry, networking circuitry, and other peripheral component circuitry. In addition, intelligent lighting module control unit 200 may include operative application software such as network software for communicating with other computing devices, database software for building and maintaining databases, and task management software for distributing the communication and/or operational workload amongst various CPU's. In some cases, intelligent lighting module control unit 200 is a single hardware device having the hardware and software listed herein, and in other cases, intelligent lighting module control unit 200 is a networked collection of discrete hardware and software devices working together to execute the functions of the dermal injector. The conventional hardware and software of intelligent lighting module control unit is not shown in the figures for simplicity.

Software stored in memory 202a may include a fully executable software program, a simple configuration data file, a link to additional directions, or any combination of known software types. When the intelligent lighting module control unit 200 updates software, the update may be small or large. For example, in some cases, intelligent lighting module control unit 200 downloads a small configuration data file, and in other cases, intelligent lighting module control unit 200 completely replaces all of the functional program instructions in memory 202a with a fresh version. In some cases, the software and data in memory 202a is encrypted, encoded, and/or otherwise compressed for reasons that include security, privacy, data transfer speed, data cost, or the like.

When so arranged as described herein, the intelligent lighting module control unit 200 is transformed from a generic and unspecific computing device to a combination device comprising hardware and software configured for a specific and particular purpose.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

Generally, unless otherwise indicated, the materials for making the invention and/or its components may be selected from appropriate materials such as metal, metallic alloys, semiconductors, ceramics, plastics, etc.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described exemplary embodiments, but should be defined only in accordance with the following claims and their equivalents.

1. An intelligent lighting and sensor system, comprising:
a processor;
a memory, the memory arranged to store program logic software, the program logic software executable by the processor;
a light control module coupleable to at least one light source wherein the light control module is operated according to the program logic software that is executed by the processor; and
a sensor interface coupleable to a plurality of sensor devices, wherein the sensor interface is operated according to the program logic software that is executed by the processor, the sensor devices including one or more ambient light sensors, infrared proximity sensors, image capture devices, or combinations thereof, wherein a higher light output is produced when people are detected and a lower light output is produced when people are not detected.

2. The intelligent lighting and sensor system of claim 1, wherein the processor and the sensor interface detect a fall of an individual using sensor data.

3. The intelligent lighting and sensor system of claim 1, further comprising a network interface that communicates with other intelligent lighting and sensor systems in a network, wherein data received from multiple intelligent lighting and sensor systems in the network enables shadows, reflections, and artificial light produced by the other sources to be identified, which assists in determining proper light output from each individual intelligent lighting and sensor system.

4. The intelligent lighting and sensor system of claim 1, comprising:
a spectral analysis sensor, wherein the spectral analysis sensor receives spectral data and distinguishing natural light from artificial light produced by other sources, wherein light output from the intelligent lighting and sensor system is dynamically adjusted in response to the received spectral data.

5. The intelligent lighting and sensor system of claim 4, wherein the spectral analysis sensor determines when an object has entered a proximate area of the intelligent lighting and sensor system and determines a size of the object based at least in part on a degree of change detected by the spectral analysis sensor.

6. The intelligent lighting and sensor system of claim 4, wherein detection of a large degree of change by the spectral analysis sensor results in a security alert, and detection of a small degree of change by the spectral analysis sensor does not result in a security alert.

7. The intelligent lighting and sensor system of claim 4, wherein spectral analysis by the spectral analysis sensor is used to modify a light output by the intelligent lighting and sensor system by adjusting tones, saturation levels, hues, glare, other light parameters, or combinations thereof.

8. The intelligent lighting and sensor system of claim 1, further comprising a wireless controller that communicates information to and from the intelligent lighting and sensor system.

9. The intelligent lighting and sensor system of claim 8, wherein the intelligent lighting and sensor system communicates with other intelligent lighting and sensor systems and operate as network repeaters to send voice data from one intelligent lighting and sensor system to another in a peer-to-peer configuration.

10. The intelligent lighting and sensor system of claim 8, wherein the wireless controller communicates with mobile devices worn by individuals that are proximate to the intelligent lighting and sensor system.

11. The intelligent lighting and sensor system of claim 10, wherein the mobile devices include smart phones, smart watches, tablet computers, laptop computers, automobile-based computers, or combinations thereof.

12. The intelligent lighting and sensor system of claim 10, wherein the intelligent lighting and sensor system receives information from one or more of the mobile devices that affects the light output of the intelligent lighting and sensor system.

13. The intelligent lighting and sensor system of claim 12, wherein the intelligent lighting and sensor system receives information from one or more of the mobile devices notifying the intelligent lighting and sensor system of mobile device wearers being present in a vicinity of the intelligent lighting and sensor system.

14. The intelligent lighting and sensor system of claim 12, wherein the intelligent lighting and sensor system receives information from one or more of the mobile devices notifying the intelligent lighting and sensor system of special needs of a mobile device wearer that is in a vicinity of the intelligent lighting and sensor system.

15. The intelligent lighting and sensor system of claim 10, wherein the intelligent lighting and sensor system sends information to one or more of the mobile devices in response to detecting one or more mobile device wearers in a vicinity of the intelligent lighting and sensor system.

16. The intelligent lighting and sensor system of claim 15, wherein the information sent from the intelligent lighting and sensor system to the one or more mobile devices alerts the wearers of the mobile devices of local weather conditions.

17. The intelligent lighting and sensor system of claim 15, wherein the information sent from the intelligent lighting and sensor system to the one or more mobile devices alerts the wearers of the mobile devices of local traffic conditions.

18. The intelligent lighting and sensor system of claim 15, wherein the information sent from the intelligent lighting and sensor system to the one or more mobile devices includes video information, audio information, textual information, tactile information, or combinations thereof.

19. The intelligent lighting and sensor system of claim 1, further comprising recognition modules including facial recognition, biometric recognition, or combinations thereof.

20. The intelligent lighting and sensor system of claim 1, wherein the intelligent lighting and sensor system is incorporated into a traffic control signal and is used in automobile traffic control.

21. The intelligent lighting and sensor system of claim 1, wherein the intelligent lighting and sensor system is incorporated into a crosswalk signal and is used in pedestrian traffic control.

22. The intelligent lighting and sensor system of claim 1, further comprising a security logic module coupleable to at least one security device.

23. The intelligent lighting and sensor system of claim 22, wherein the security logic module includes short range secure controller that includes a near field communication (NFC) controller, a radiofrequency identifier (RFID) controller, or combinations thereof.

24. The intelligent lighting and sensor system of claim 1, wherein the intelligent lighting and sensor system notifies remote safety personnel of a security event or an emergency event.

25. The intelligent lighting and sensor system of claim 1, wherein the intelligent lighting and sensor system provides emergency lighting in response to a security event or an emergency event, wherein the emergency lighting includes flashing lights, strobe lighting, sequential lighting, colored lighting, or combinations thereof.

26. The intelligent lighting and sensor system of claim 1, further comprising an audio controller coupleable to at least one audio device wherein operation of the audio controller is directed according to the program logic software executed by the processor, wherein the audio controller sounds an alarm in response to a security event or an emergency event.

27. The intelligent lighting and sensor system of claim 26, wherein the audio controller enables remote safety personnel to speak to local individuals in response to the security event or the emergency event.

28. The intelligent lighting and sensor system of claim 27, wherein an the emergency event includes, a fall of an individual, a traffic accident between vehicles, a traffic accident involving a vehicle and a pedestrian, a traffic accident involving vehicle and a stationary object, or combinations thereof.

29. The intelligent lighting and sensor system of claim 27, wherein the security event includes an attack on an individual, a robbery of an individual, burglary, trespassing, malicious mischief, or other act of violence.

30. The intelligent lighting and sensor system of claim 1, further comprising a power entry device that conforms to a HomePlug protocol.

31. The intelligent lighting and sensor system of claim 8, wherein the wireless controller conforms to at least one of a cellular protocol and a WiFi protocol.

32. A method of providing intelligent lighting in response to sensed information, the method comprising:
providing a processor and a memory, the memory arranged to store program logic software that is executable by the processor;
receiving light and image information via a sensor interface and a plurality of sensor devices, the sensor devices including one or more ambient light sensors, infrared proximity sensors, image capture devices, or combinations thereof;
producing, via a light control module coupleable to at least one light source, a higher light output is produced when people are detected and a lower light output is produced when people are not detected; and
receiving spectral data, via a spectral analysis sensor, and distinguishing natural light from artificial light produced by other sources, wherein light output from the intelligent lighting and sensor system is dynamically adjusted in response to the received spectral data.

33. An intelligent lighting and sensor system, the system comprising:
a processor;
a memory, the memory arranged to store program logic software, the program logic software executable by the processor;
a light control module coupleable to at least one light source wherein the light control module is operated according to the program logic software that is executed by the processor;
a sensor interface coupleable to a plurality of sensor devices, wherein the sensor interface is operated according to the program logic software that is executed by the processor, wherein the sensor devices include one or more ambient light sensors, infrared proximity sensors, image capture devices, or combinations thereof; and
a wireless controller, wherein the wireless controller is configured to communicate information between the intelligent lighting and sensor system and mobile devices worn by individuals that are proximate to the intelligent lighting and sensor system, wherein the intelligent lighting and sensor system receives information from one or more of the mobile devices that affects an output of the intelligent lighting and sensor system.
